(19) United States
(12) Patent Application Publication
(10) Pub. No.: US 2016/0144642 A1
(43) Pub. Date: May 26, 2016

(54) PRINTING DEVICE CONTROL METHOD AND SYSTEM WITH EXECUTING COMMAND DETERMINED FROM IMAGE

(71) Applicant: KYOCERA Document Solutions Inc., Osaka (JP)

(72) Inventor: Oleg Y. Zakharov, Concord, CA (US)

(21) Appl. No.: 14/551,405

(22) Filed: Nov. 24, 2014

(51) Int. Cl. B41J 29/38

(52) U.S. Cl. CPC B41J 29/38

(57) ABSTRACT

Example systems and methods may relate to controlling a printing device. Specifically, systems may include a processing device and a printing device. The processing device may be configured to determine an image corresponding to a command for performing maintenance on a printing device. Such a command may include a command to restart device, clean memory, or set sleep mode, for example. The processing device may also render the image on a portable medium. The printing device may read the image using a scanner or other reading device. The printing device may then determine that a command corresponds to the image read. The printing device may then execute the command that corresponds to the image read.

### BACKGROUND

1. Field of the Invention

Unless otherwise indicated herein, the description in this background section is not prior art to the claims in this application and is not admitted to be prior art by inclusion in this section. The present disclosure relates to a control method and system for a printing device, using the scanning functionality of the printing device to receive control information.

2. Description of the Related Art

Modern printing devices are becoming increasingly more complex with the addition of new functions, modes of use, and network connectivity. As a result, maintenance of modern printing devices has become more complicated and can require advanced skills and technical knowledge.

In most cases, maintenance of a modern printing device is carried out using the device's front panel to check and change various settings. For example, a device may need its memory cleared or its network settings changed. These operations are typically performed by a person physically located at the device, using the device's front panel.

In addition to requiring in-person maintenance, most modern printing devices require a specific set of commands that depend on the device's model, version, and supplying vendor. Thus, a technician performing maintenance may need to know many different sets of commands and settings particular to each modern printing device.

### SUMMARY

In a first embodiment, a method for controlling a printing device is provided. The method preferably includes determining an image corresponding to a command for controlling a printing device. The command is for performing maintenance on the printing device. The method includes rendering the image on a portable medium. The method also includes reading, into the printing device, the image rendered on the portable medium. The method further includes determining that the image read into the printing device contains the command for controlling the printing device. The method yet further includes executing the command.

In a second embodiment, a system for controlling a printing device is provided. The system preferably includes a processing device and a printing device. The processing device is configured to determine an image corresponding to a command for controlling a printing device. The command is for performing maintenance on the printing device. The processing device is also configured to render the image on a portable medium. The printing device is configured to receive the image as an input. The printing device is also configured to determine that the image received as input contains the command for controlling the printing device. The printing device is further configured to execute the command contained in the image.

In a third embodiment, a printing device is provided. The printing device preferably includes a processor and a memory. The printing device further includes an image receiver that receives an image corresponding to a command for a printing device. The command is for performing maintenance on the printing device. The printing device also includes a command determiner for determining whether the received image contains the command for controlling the printing device. The printing device further includes a command executor for carrying out the command contained in the image.

Other embodiments, aspects, and implementations will become apparent to those of ordinary skill in the art by reading the following detailed description, with reference where appropriate to the accompanying drawings.

### BRIEF DESCRIPTION OF THE DRAWINGS

FIG. 1 is a block diagram illustrating a printing device control system according to an embodiment of the present disclosure.

FIG. 2 is a block diagram illustrating a printing device control system according to an embodiment of the present disclosure.

FIG. 3 is a flowchart illustrating a method for controlling a printing device.

FIG. 4 is a flowchart illustrating a method for controlling a printing device according to an embodiment that includes encoding and decoding a command.

FIG. 5 is a flowchart illustrating a method for controlling a printing device according to an embodiment that includes encrypting and decrypting a command.

FIG. 6 is a schematic diagram illustrating the printer device control method according to an embodiment.

FIG. 7 is a schematic diagram illustrating the printer device control method according to an embodiment.

FIG. 8 is a schematic diagram illustrating the image generation and rendering according to an embodiment of the present disclosure.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims, are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

The disclosure relates to methods, systems, and devices for controlling printing devices. Specifically, a system may include a processing device and a printing device. The processing device may be configured to determine an image that corresponds to a command. The command may be a command for performing maintenance on a printing device. The processing device may also be configured to render the image onto a portable medium. As used herein, a portable medium may be anything upon which an image can be rendered, such as paper, cardstock, or the display of an electronic device, such as a smart phone or tablet computer. The printing device may be configured to read the image that is rendered on the portable medium. The printing device may also be configured to determine that the read image includes a command. Further, the printing device may be configured to execute the command included in the image.

### II. System Examples

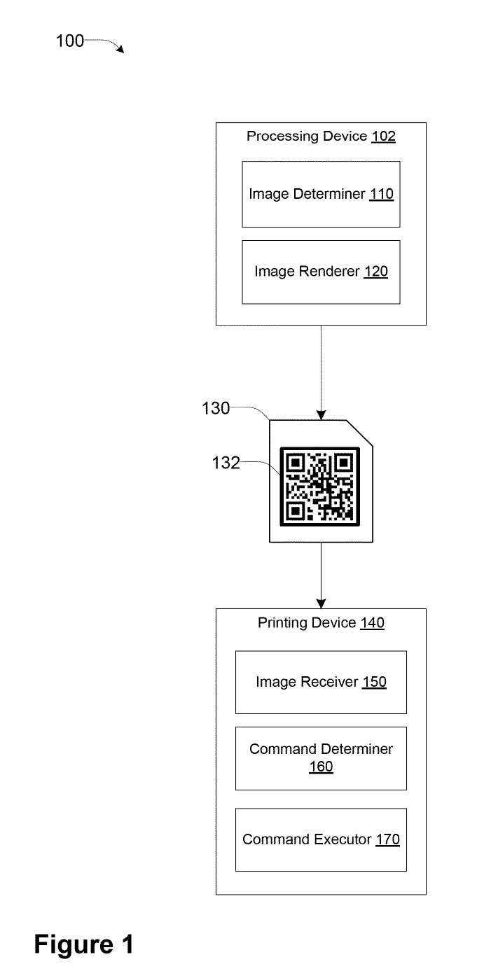

FIG. 1 is a block diagram illustrating a printing device control system 100 according to an example embodiment. The system 100 may include a processing device 102, a portable medium 130 having an image 132, and a printing device 140. The processing device 102 may include an image determiner 110 and an image renderer 120. The printing device 140 may include an image receiver 150, a command determiner 160, and a command executor 170.

In the following descriptions of the various components, the term memory may be used. The memory may take many different forms such as a hard disk drive (HDD), compact disc (CD), digital video disc (DVD), digital tape, or non-volatile flash memory such as a flash drive, secure digital (SD) card, or similar storage mediums. The memory may also be any form of volatile memory, including random access memory (RAM), for example. Further, the memory may be integrated with one or more of the described components, may be shared between one or more components (i.e., an internal memory for the entire device), or may be separate from the components.

The image determiner 110 in the processing device 102 may create an image that corresponds to a command for a printing device. Alternatively, the image determiner may select an image from a list of pre-generated images stored and/or generated locally or remotely (e.g. in a database accessible through a wired or wireless network connection). In some embodiments, the image determiner may determine the image based on an input from a user. Alternatively, the image determiner may determine the image based on some other source of input.

The image determiner 110 may include hardware, firmware, or a software application configured to determine an image corresponding to a command. The image determiner may also include a memory and a processor. For example, the image determiner 110 may include a set of program instructions stored on a memory that, when executed by a processor, causes an image corresponding to a command to be selected. The image determiner 110 may also include a user interface, such as a keyboard and/or mouse, which may allow a user to input an image selection. Further, the image determiner 110 may include a network interface, which may allow an image selection to be input by a remote device, such as a PC or tablet computer, over a wired or wireless network.

The image renderer 120 in the processing device 102 may render the image 132 onto the portable medium 130. In some embodiments, the image renderer 120 may be a personal printer, a networked or shared printer, a virtual printer, or another type of printing device. Alternatively, the image renderer 120 may be comprised of a set of instructions on a computer-readable medium that, when executed, causes the image 132 to be displayed on a display screen of a portable electronic device.

The image renderer 120 may include hardware, firmware, or a software application configured to cause an image to be rendered on a portable medium, as well as memory and a processor. The image renderer may also include a print head, one or more ink cartridges, and a paper feed assembly (i.e. an inkjet printer). Alternatively, the image renderer 120 may include a laser printer assembly, having a laser scanning unit, photoreceptor drum, toner hopper, fuser, and developer roller (i.e., a laser printer). Further, the image renderer may include a set of program instructions stored on a memory that, when executed by a processor, causes an image to be displayed on a display screen. The display screen may include a liquid crystal display (LCD), light-emitting diode (LED) display, organic light-emitting diode (OLED) display, active-matrix organic light-emitting diode (AMOLED) display, Retina Display, or any other type of suitable display.

The portable medium 130 may be comprised of any material on which an image can be printed, displayed, or affixed. For example, the portable medium may be paper, or alternatively it may be a portable electronic device with a screen, as discussed above. In some embodiments, one or both of the image determiner 110 and image renderer 120 may be integrated with the portable medium 130. For example a portable electronic device such as a smart phone or tablet computer may include a display screen, as well as instructions configured to carry out the acts described above in reference to the image determiner and/or image renderer. The image 132 may be any image or object (e.g. a 3D-printed object) that corresponds to a command for a printing device. For instance, the image may be in the form of a barcode or quick response (QR) code.

The image receiver 150 in the printing device 140 may read the image 132 into the printing device 140. In at least one embodiment, the image receiver 150 is a scanner. The scanner may be a component of the printing device, for example, providing one function of a multifunction printing (MFP) device. As used herein, an MFP device is any printing device that, in addition to printing, can perform at least one other function such as scanning, copying, or faxing. Alternatively, the scanner may take the form of a scanning device physically separate from the printing device. In some embodiments, the image receiver 150 may take the form of a stand-alone or integrated scanner, digital camera, barcode scanner, or other electronic device that can read an image. An image receiver 150 that is physically separate from the printing device may be connected to the printing device via a wired or wireless data link or communication network.

The image receiver 150 in the printing device 140 may include hardware, firmware, or a software application configured to receive an image as input, as well as memory and a processor. The image receiver may include a set of program instructions stored on a memory that, when executed by a processor, causes an image to be read into the printing device. The image receiver may include mirrors, a lens, filters, a charge-coupled device (CCD) array, a lamp, a motor, a power supply, interface ports, and control circuitry (i.e. a flatbed scanner). In some embodiments, the image receiver may include one or more lenses, an aperture and shutter, filters, an analog-to-digital converter, a CCD array, a microprocessor, and a user interface (i.e., a digital camera). In other embodiments, the image receiver may include a pen-type or laser barcode scanner, which include a light source, a photo diode, a housing, and control circuitry.

The command determiner 160 in the printing device 140 may determine whether the image 132 read into the printing device 140 by the image receiver 150 contains a command for controlling the printing device. The command determiner 160 in the printing device 140 may include hardware, firmware, or a software application configured to determine whether a command is contained in the image read into the printing device, as well as a memory and a processor.

As an example, the command determiner 160 in the printing device 140 may include a plurality of predetermined supported commands, stored in a list, database, array, or other storage structure in the memory. The command determiner 160 may compare the information contained in the image (as opposed to the image itself) to the predetermined supported commands. Specifically, the command determiner may convert the image 132 read into the printing device into an alphanumeric code, based on the content of the image. For example, a barcode may be converted from a series of vertical lines to a numeric code based on the spacing and thickness of the lines. As another example, a QR code image may be converted to an alphanumeric code based on the size and positioning of the dots located in the image. The command determiner may then compare the numeric or alphanumeric code contained in the image to a predetermined list of codes stored in the memory (i.e. predetermined supported commands). The command determiner may determine there is a command included in the image if there is a match.

In another embodiment, the command determiner 160 may include a plurality of pre-determined images (e.g., barcodes or QR codes representing commands supported by the printing device) stored in a list, database, array, or other storage structure in the memory. The pre-determined images may be stored in any appropriate file format, such as JPEG, Exif, TIFF, RIF, GIF, BMP, or PNG, for example. The command determiner 160 may compare the image 132 read into the printing device to the plurality of stored images. The command determiner may then determine that there is a match, and therefore determine that a command is included in the image read into the printing device.

In still another embodiment, the command determiner may include a user interface. As such, the command determiner may determine that a command is included in an image read into the printing device by receiving an indication from a user through a user interface.

In some embodiments the image receiver 150 and/or command determiner 160 may be physically separate from the printing device, but connected to it via a wired or wireless connection such as Ethernet, Universal Serial Bus (USB), RS-232, Wi-Fi, local area network (LAN), wide area network (WAN), or any other communication network.

The command executor 170 in the printing device 140 may execute the command contained in the image 132 that has been read into the printing device 140. The command executor may include hardware, firmware, or a software application configured to execute a command. The command executor may include one or more processors, such as general purpose processors, special purpose processors, microprocessors, or digital signal processors (DSPs), for example. The command executor may also include a set of program instructions stored on a memory that, when executed by a processor, cause the command executor to perform a command. As an example, where the command is a maintenance command such as ‘restart device,’ the command executor may cause the processor to execute the set of instructions that cause the printing device to restart.

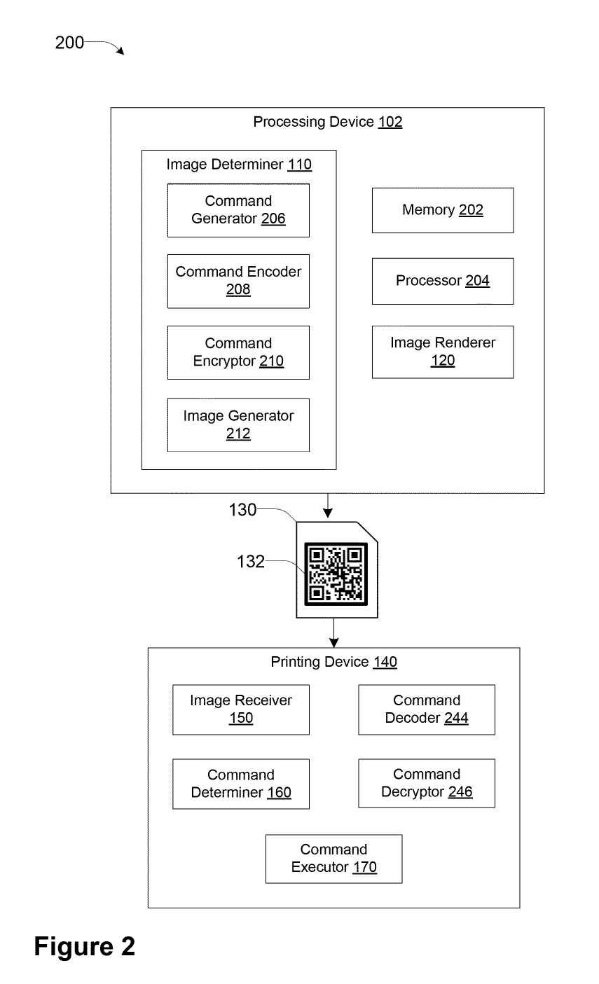

FIG. 2 is a block diagram illustrating a printing device control system 200 according to an example embodiment. The system 200 may include the processing device 102, the portable medium 130 having an image 132, and the printing device 140 generally described above in connection with FIG. 1. In the system 200, the processing device 102 may include an image determiner 110 and an image renderer 120. In at least one embodiment, the processing device may also include a memory 202 and a processor 204. The memory 202 may take many different forms such as a hard disk drive (HDD), compact disc (CD), digital video disc (DVD), digital tape, or non-volatile flash memory such as a flash drive, secure digital (SD) card, or similar storage mediums. The memory 202 may also be any form of volatile memory, including random access memory (RAM), for example.

In one or more embodiments, the image determiner 110 in the processing device 102 may include a command generator 206. The command generator 206 may include hardware, firmware, or a software application configured to generate a command, as well as memory and a processor. For example, the command generator 206 may include a set of program instructions stored on a memory that, when executed by a processor, causes a command to be generated or selected. The command generator 206 may create a command, select a command from a pre-determined list of commands stored on a memory, or otherwise generate a command for controlling a printing device. In some embodiments, the printing device has a pre-determined set of application programming interface (API) commands that are supported. The command generator may select a command from this set of supported commands. Example commands for maintaining a printing device include causing a printing device to restart, clear memory, print out a status report, or set sleep mode. Many other commands are possible. The command generator may also include a user interface, such as a keyboard and/or mouse, which may allow a user to input a command selection. Further, the command generator 206 may include a network interface, which may allow a command selection to be input by a remote device, such as a PC or tablet computer, over a wired or wireless network.

In some embodiments, the image determiner 110 in the processing device 102 may include a command encoder 208. The command encoder 208 may include hardware, firmware, or a software application configured to encode a command. The command encoder 208 may also include memory and a processor. The command encoder 208 may include a set of program instructions stored on a memory that, when executed by a processor, causes a command to be encoded. The command encoder 208 may encode the command into an alphanumeric format. As an example, the command ‘restart device’ may be encoded into the form ‘H.’ The command encoder may also include encoding a command type, a check sum, any associated data, or other relevant information.

In one embodiment, the command encoder 208 may encode some or all of the possible commands prior to selection by the command generator 206. The encoded commands may be stored on a memory as a list of encoded commands. In another embodiment, the command encoder 208 may dynamically encode a command after it is selected by the command generator. For example, generation of a given command may require additional information that is not available until the command is chosen, such as a command to print a status report (i.e., the report number may be required). In that case, the command encoder may use the selected command and other information, such as command type, check sum, and associated data (e.g., the report number), and dynamically create an encoded command from that information.

In one or more embodiments, the image determiner 110 in the processing device 102 may also include a command encryptor 210. The command encryptor 210 may encrypt the command so that a printing device cannot execute the command unless the command is first decrypted. This may be to prevent unauthorized persons from controlling the printing device, or to prevent an unauthorized printing device from executing the command. The encryption may occur before or after a command is determined by the command generator. The encryption may also occur instead of, or in addition to, the encoding of the command by the command encoder.

The command encryptor 210 may include hardware, firmware, or a software application configured to encrypt a command. The command encryptor may also include memory and a processor. For example, the command encryptor 210 may include a set of program instructions stored on a memory that, when executed by a processor, causes a command to be encrypted. Any method of encryption may be used by the command encryptor, such as hashing encryption, symmetric key encryption, or asymmetric key encryption, for example.

The image determiner 110 in the processing device 102 may also include an image generator 212. The image generator 212 may generate an image from the command generated or selected by the command generator 206. In some embodiments, the image generator may generate an image from an encoded and/or encrypted command. In other embodiments, the image generator may select an image from a pre-determined set of images corresponding to commands for a printing device.

The image generator 212 may include hardware, firmware, or a software application configured to generate an image. The image generator 212 may also include memory and a processor. For example, the image generator 212 may include a set of program instructions stored on a memory that, when executed by a processor, causes an image to be generated based on a command. The generated image may be a barcode or QR code image, for example. FIG. 2 shows, as an example, a QR code rendered on the portable medium 130. The generated image may be of any form such that it corresponds to a command for controlling a printing device.

As described above with reference to FIG. 1, the image renderer 120 may render an image 132 onto a portable medium 130. The image renderer 120 may comprise a set of instructions on a computer-readable medium that, when executed, causes the image 132 to be displayed on a display screen of an electronic device. In some embodiments, one or more components of the processing device 102 may be integrated with the portable medium 130. For example a portable electronic device such as a smart phone or tablet computer may include the display screen (on which the image 132 may be rendered), as well as instructions configured to carry out the acts described above in reference to the processing device 102.

The system 200 may also include a printing device 140. The printing device 140 may include some or all of the components discussed above in connection with the printing device 140 in FIG. 1. In addition, the printing device 140 may also include a command decoder 244 and/or a command decryptor 246.

The command decoder 244 may decode the encoded command corresponding to the image read into the printing device. The command decoder 244 may include hardware, firmware, or a software application configured to decode a command. The command decoder 244 may also include memory and a processor. The command decoder 244 may include a set of program instructions stored on a memory that, when executed by a processor, causes a command to be decoded. For example, the command decoder 244 may convert the image 132 received by the printing device into an alphanumeric format. The command decoder 244 may convert a bar code image that includes various vertical lines into an alphanumeric format using the spacing and thickness of the lines. In another example, the command decoder 244 may convert a QR code image into an alphanumeric format by using the spacing and size of the dots contained in the QR code image.

In some embodiments, the command decoder 244 may decode the command contained in the image 132 by parsing the command into its components, namely the command code, command type, check sum, and associated data, for example. This may allow the printing device to perform further operations, such as decryption and/or execution.

The printing device 140 may also include a command decryptor 246, which may decrypt the command. The command decryptor 246 may include hardware, firmware, or a software application configured to decrypt a command. The command decryptor 246 may also include memory and a processor. The command decryptor 246 may include a set of program instructions stored on a memory that, when executed by a processor, causes a command to be decrypted. The set of instructions may cause an encrypted command to be converted to a decrypted form by applying a decryption algorithm, which may depend upon the method of encryption used by the processing device. For example, the command decryptor 246 may use a decryption key, which may be the same key used for encryption (symmetric key encryption) or a different key (asymmetric key encryption). Other types of decryption are possible.

### III. Method Examples

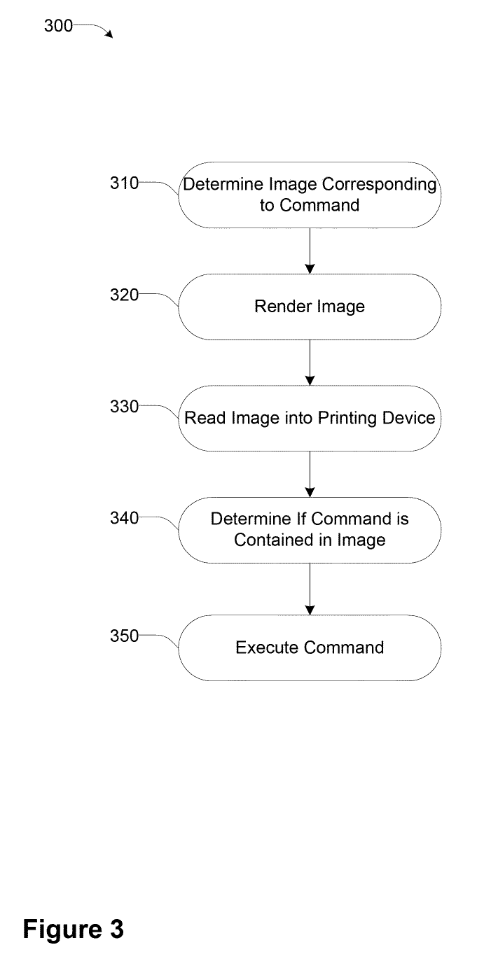

FIGS. 3-5 are flowcharts illustrating example methods for controlling a printing device. The methods include blocks that may be carried out in an order different from the order shown. In addition, various steps may be added to or removed from the described methods without departing from the intended scope of this disclosure. The methods may correspond to steps that may be carried out using some or all of the elements of the systems 100 and 200, as illustrated in and described with reference to FIGS. 1 and 2.

FIG. 3 is a flowchart illustrating a method 300 for controlling a printing device according to an example embodiment. Step 310 includes determining an image corresponding to a command for controlling a printing device. This step may include determining an image corresponding to a command for controlling a printing device, wherein the command is for performing maintenance on the printing device. In some embodiments, this step may entail dynamically creating a command for performing maintenance on a printing device. As an example, a command to print out a specific report may require a report number, chosen by a user, to be included with the command. As such, step 310 may include receiving the chosen report number, and then dynamically generating a command which includes the chosen report number. Alternatively, step 310 may include choosing a command from a list of predetermined commands. Step 310 may further include generating or selecting an image corresponding to the generated or chosen command.

Step 320 includes rendering the image on a portable medium. For example, step 320 may include printing an image corresponding to a command on a portable medium such as paper, cardstock, or other similar medium. Alternatively, step 320 may include displaying the image corresponding to a command on the screen of a portable electronic device such as a smartphone, tablet computer, or other electronic medium.

Step 330 includes reading the image into a printing device. In one embodiment, this step may be performed by a scanner. The scanner may be a component of the printing device, for example as one function of an MFP device. Alternatively, step 330 may be performed by a stand-alone scanner, digital camera, barcode scanner, or other electronic device that can read an image. These example devices may be connected to the printing device via a wired or wireless data link or communication network.

Step 340 includes determining if a command is contained in the image. In one embodiment, step 340 may include comparing the image read into the printing device to a set of pre-determined images. In another embodiment, step 340 may include converting the image into an alphanumeric form. The step may then include comparing the alphanumeric command to a list of predetermined commands to determine if a match is present. In another embodiment, step 340 may include determining that a command is contained in the image based on the content of the image or placement of the image on the portable medium. For example, the printing device may determine that a command is present each time a barcode or QR code is read into the device.

Step 350 includes executing the command. The command may be for performing maintenance on a printing device, which may include causing a printing device to restart, clear memory, print out a status report, or set sleep mode. Many other commands are possible.

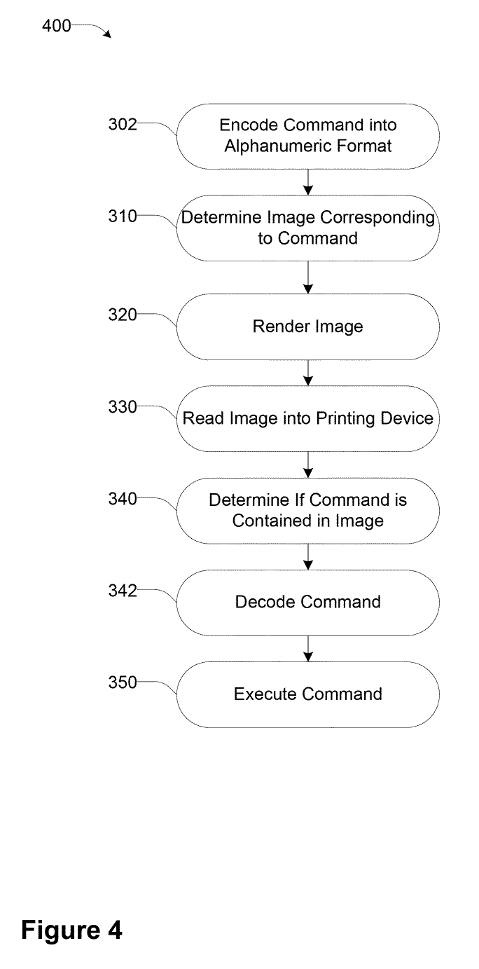

FIG. 4 is a flowchart illustrating a method 400 for controlling a printing device according to an embodiment that includes encoding and decoding a command. The method 400 may be similar or identical to the method 300 in some respects. The method 400 includes additional steps 302 and 342, which correspond to encoding and decoding the command respectively. Step 302 includes encoding a command into alphanumeric format. As discussed previously, the command for controlling a printing device may include causing a printing device to restart, clear memory, print out a status report, or set sleep mode, for example. Each of these commands may be encoded into an alphanumeric format, such that each command has a unique code. For example, each command may be encoded as a number between 0 and 255. In addition, command type, check sum, any associated data and/or relevant information may be encoded as well.

Step 342 includes decoding the command. The printing device may decode the command from an alphanumeric format into a different format. For example, if the command encoded in the image is a number between 0 and 255, the step 342 of decoding the command may include converting the number into something meaningful to the printing device, such as bit patterns corresponding to ‘restart device,’ ‘clear memory,’ ‘print out a status report,’ or ‘set sleep mode.’

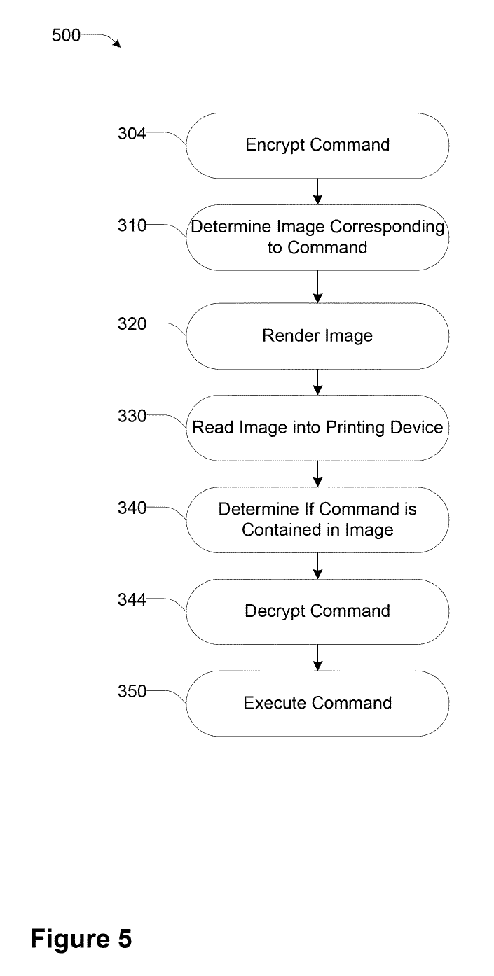

FIG. 5 is a flowchart illustrating a method 500 for controlling a printing device according to an embodiment that includes encrypting and decrypting a command. The method 500 may be similar or identical to the method 300 in some respects. The method 500 includes additional steps 304 and 344, which correspond to encrypting and decrypting the command respectively. Step 304 includes encrypting the command. In at least one embodiment, the command may be encrypted before an image is rendered. The encryption may be hashing encryption, symmetric key encryption, or asymmetric key encryption, for example. This step may be done to prevent unauthorized persons from controlling the printing device, or to prevent an unauthorized printing device from executing the command. The method 500 may also include decrypting the command as shown in step 344.

### IV. Other Examples

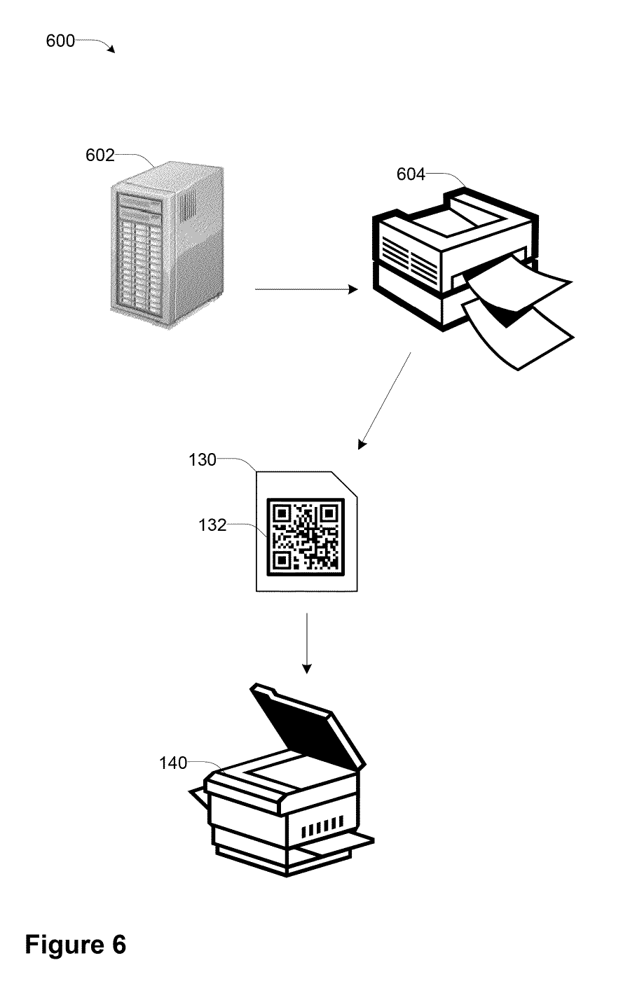

FIG. 6 is a schematic diagram illustrating the printer device control method according to an embodiment. In one embodiment, a server 602 creates, selects, or otherwise generates a command. The command may be chosen by a user through the use of a user interface, such as a keyboard and/or mouse. Alternatively, the command may be created, selected, or generated based on input from a device connected to the server 602 via a wired or wireless network interface. This may allow the server to receive input from a remote device, such as a PC or tablet computer, for example. In one embodiment, server 602 may contain a list of commands that may control a variety of printing device models and versions. As such, the server 602 may allow a person performing maintenance on a remotely located printing device to request a command specific to a given device from a central server even though he or she is not physically present at the server location. In addition, it may allow a person unfamiliar with the specific printing device at issue to be able to control and perform maintenance by using a command created, selected, or generated by the server.

The server 602 may be any type of computer server or computing device, and may be connected to a printer 604 via a wired or wireless connection such as Ethernet, Universal Serial Bus (USB), RS-232, Wi-Fi, local area network (LAN), wide area network (WAN), or any other method of connection. The server 602 may process the command by encoding or encrypting the command as described in connection with FIG. 2. The printer 604 may receive the image from the server 602, and then may render the image 132 onto the portable medium 130 by printing the image onto paper, for example.

The printing device 140 may then read the image 132 in a manner the same as or similar to that described in connection with FIGS. 1 and 2. The printing device may optionally decode and/or decrypt the command contained in the image. The printing device may then execute the command.

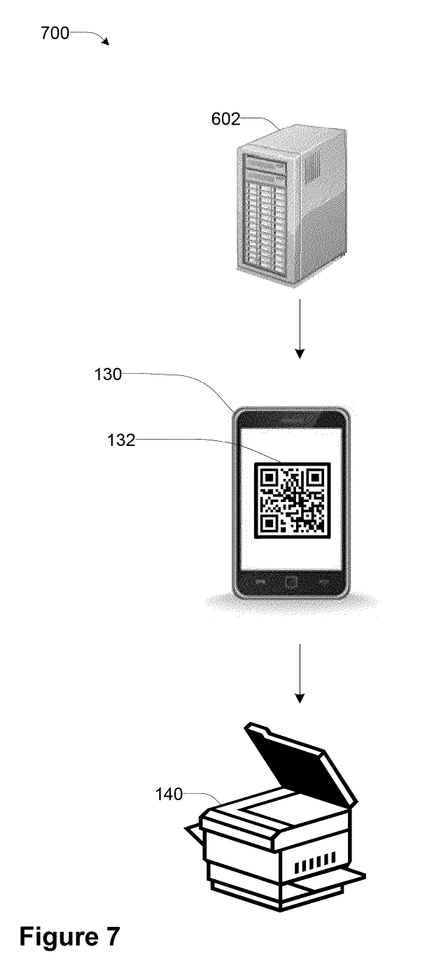

FIG. 7 is a schematic diagram illustrating the printer device control method according to an embodiment. The method of FIG. 7 may be similar or identical in some respects to the method shown in FIG. 6. In one embodiment, the server 602 creates, selects, or otherwise generates a command. The creation, selection, or generation of the command may be in a manner similar to or the same as that described above in connection with FIG. 6. The server 602 may communicate with a portable medium 130 via a wired or wireless communication network. The portable medium 130 may be a portable electronic device with a display. The server 602 may create, select, or generate an image 132 corresponding to a command, and send the image over the communication network to the portable electronic device 130. The portable electronic device may then display the image 132 on its display screen. In one embodiment, the portable electronic device may include an application or set of computer-readable instructions that, when executed by a processor on the portable electronic device, causes the portable electronic device to perform the actions of the server 602. In other words, the server 602 and portable medium 130 may be embodied within a single (unitary) portable electronic device. The application or instructions may determine a command and generate or select an image corresponding to the command. The portable electronic device may then display the image on its display screen.

Printing device 140 may then read in the image displayed on the display screen of the portable electronic device by scanning the display screen. In some embodiments, the scanner may be a component of the printing device; for example, as one function of an MFP device. Alternatively, the scanner may take the form of a device physically separate from the printing device. Printing device 140 may then execute the command corresponding to the image 132.

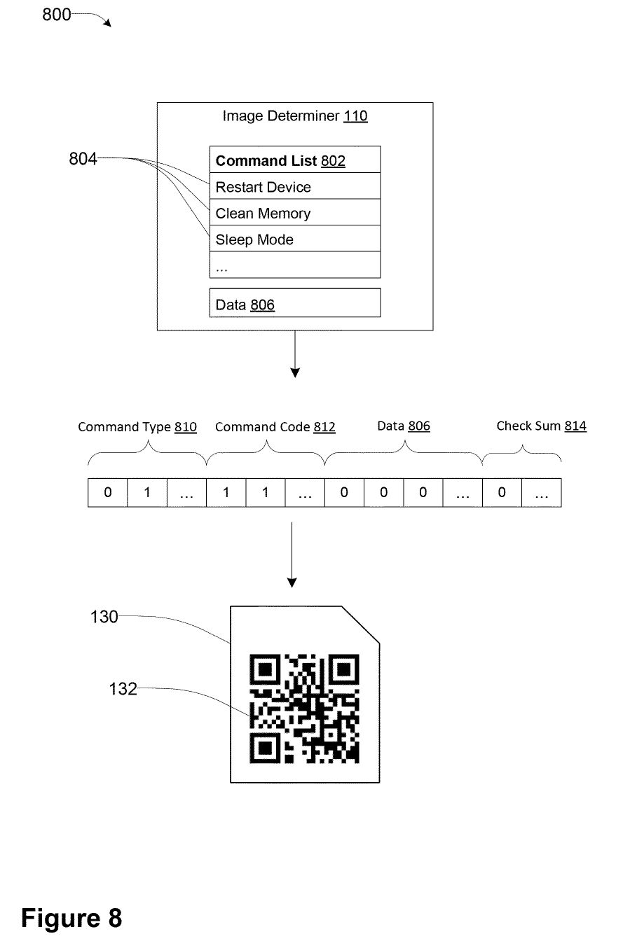

FIG. 8 is a schematic diagram illustrating the image generating and rendering according to an example embodiment. In at least one embodiment, an image determiner 110 includes a command list 802. The command list 802 contains a list of commands 804 for controlling a printing device. Specifically, the commands may be for performing maintenance on a printing device, and may include causing a printing device to restart, clear memory, print out a status report, or set the device in or out of sleep mode. In some embodiments, there may be data 806 associated with the commands 804. The data may be a status report number, a value indicating whether sleep mode should be on or off, a value of a setting to be modified, network communication information, or any other data related to maintenance of a printing device.

The method 800 may include encoding the command into an alphanumeric format.

For example, an encoded command may include a command type 810, a command code 812, data 806, and a check sum 814. The command type 810 may be a representation of the type of command to be performed by the printing device. The type of command may indicate whether any data 806 is associated with the command. For example, ‘restart device’ may not require any data, and the encoded command may have a command type of ‘01’ to indicate no data is included. However, setting ‘sleep mode’ may require additional data to indicate whether sleep mode should be on or off, in which case the encoded command may have a command type value of ‘10’ to indicate that associated data is included.

The command code 812 may include an alphanumeric value that indicates the command to be performed by the printing device. The command code may be a value between 0 and 255. For example, the command code for restart device may be ‘H.’ The method 800 may also include encoding a check sum 814. The check sum may include a value used for error detection and/or correction in the event a value is incorrectly transmitted to the printing device or some other error occurs.

The method 800 may also include converting the command from an alphanumeric form to an image form, such as a QR code or barcode. Any image that corresponds to the encoded command may be used. The image may then be printed or displayed on a portable medium 130.

While various examples and embodiments have been disclosed, other examples and embodiments will be apparent to those skilled in the art. The various disclosed examples and embodiments are for purposes of illustration and are not intended to be limiting, with the true scope indicated by the following claims.

1. A method for controlling a printing device, comprising:
determining, at a processing device, a command for performing maintenance on the printing device;
determining, at the processing device, an image corresponding to a command for controlling a printing device;
rendering the image on a portable medium;
reading, into the printing device, the image rendered on the portable medium;
determining that the image read into the printing device contains the command for controlling the printing device; and
executing the command, if the image is determined to contain the command for controlling the printing device.

2. The method of claim 1, wherein the command is encoded into an alphanumeric format before being used to render the image.

3. The method of claim 1, wherein the image rendered on the portable medium is in a form of at least one of a bar code and a QR code.

4. (canceled)

5. The method of claim 1, further comprising encrypting the command for controlling the printing device.

6. The method of claim 5, further comprising decrypting the encrypted command after the image is read.

7. The method of claim 1, wherein the portable medium on which the image is rendered comprises an electronic device with a display.

8. The method of claim 1, wherein the portable medium on which the image is rendered comprises paper.

9. A system for controlling a printing device, comprising:
a processing device configured to:
determine a command for performing maintenance on the printing device;
determine an image corresponding to a command for controlling a printing device, wherein the command is for performing maintenance on the printing device; and
render the image on a portable medium; and
a printing device configured to:
receive the image as an input;
determine that the image received as input contains the command for controlling the printing device; and
execute the command contained in the image, if the image is determined to contain the command for controlling the printing device.

10. The system of claim 9, wherein the processing device is further configured to encode the command into an alphanumeric format before determining the image.

11. The system of claim 9, wherein the image rendered on the portable medium is in a form of at least one of a bar code and a QR code.

12. (canceled)

13. The system of claim 9, wherein the processing device is further configured to encrypt the command for controlling the printing device.

14. The system of claim 13, wherein the printing device is further configured to decrypt the encrypted command after the image is received as an input.

15. The system of claim 9, wherein the processing device is a handheld electronic device having a display.

16. The system of claim 15, wherein the portable medium on which the image is rendered comprises the display of the handheld electronic device.

17. The system of claim 9, wherein the processing device is a server.

18. The system of claim 9, wherein the portable medium on which the image is rendered comprises paper.

19. A printing device comprising:
a memory;
a processor;
an image receiver that receives, from a processing device, an image corresponding to a command for a printing device, wherein the command is determined at the processing device, for performing maintenance on the printing device;
a command determiner for determining whether the received image contains the command for controlling the printing device; and
a command executor for carrying out the command contained in the image, if the image is determined to contain the command for controlling the printing device.

20. The device of claim 19, wherein the image receiver is a scanner attached to the printing device.

21. The method of claim 2, wherein the printing device has a memory including a predetermined list of a plurality of codes, and wherein determining if the image read into the printing device contains the command for controlling the printing device, comprises:
converting the command image to a code in the alphanumeric format; and
comparing the converted code to the predetermined list of the plurality of stored codes.

22. The method of claim 1, wherein the printing device has a memory including a predetermined list of a plurality of images, and wherein determining if the image read into the printing device contains the command for controlling the printing device, comprises:
comparing the determined command image to the predetermined list of the plurality of stored images.
